(19) United States
(12) Patent Application Publication
(10) Pub. No.: US 2016/0022095 A1
(43) Pub. Date: Jan. 28, 2016

(54) ELECTRIC EGG BEATER

(71) Applicant: Wei YANG, NingBo (CN)

(72) Inventor: Wei YANG, NingBo (CN)

(21) Appl. No.: 14/753,920

(22) Filed: Jun. 29, 2015

(30) Foreign Application Priority Data
Jul. 28, 2014 (CN) 201410370187.4
Jul. 28, 2014 (CN) 201420426008.X

(51) Int. Cl. A47J 43/08; B01F 15/02; B01F 9/00; B01F 13/04; A23L 1/32; B01F 15/00

(52) U.S. Cl. CPC A47J 43/08; A23L 1/32; B01F 15/00538; B01F 15/0074; B01F 9/003; B01F 13/045; B01F 15/0294; B01F 15/00389; A23V 2002/00; B01F 2215/0014

(57) ABSTRACT

An electric egg beater, comprising a housing, a motor, a circuit board and a holding device; wherein the holding device comprise one or more clamps for holding an egg with eggshell; wherein the holding device is configured to be connected to a motor; wherein the circuit board is configured to control the motor to rotate clockwise and counterclockwise; wherein the motor is configured to drive the holding device to rotate the egg held therein clockwise and counterclockwise in alternation. The electric egg beater enables the egg white and egg yolk to be mixed uniformly and rapidly without breaking the egg shell. No mixing vessel is involved in the mixing, thereby saving the labor for washing and preventing the egg liquid from exposing in the air. The uniformly mixed shell-intact egg can be boiled directly; the taste is soft and smooth, and the product is compact and golden yellow, which facilitates the dish carving and creation. In addition, no pure yolk is produced, thereby avoiding the hidden danger of chocking of elderlies and children.

### BACKGROUND OF THE INVENTION

The invention relates to an electric egg beater.

### FIELD OF THE INVENTION

Featuring abundant nutrients, high edible value and low price, egg is popular among consumers as a food material. With the increasing demand of the food material, its sanitary conditions, operation convenience and taste have attracted more attention than ever before. Typically, to obtain a mixed egg liquid, an egg is broken and the egg liquid is poured into a mixing vessel for stirring. Unfortunately, the egg liquid is exposed in the air for a long time, which increases the probability of contamination. In addition, the mixing vessel needs washing, which increases the work load. In general, a shell-containing egg can only be boiled to eat. However, the boiled egg has dry and rough yolk and singular taste, so it is unpopular among people, particularly for elderlies and children; the dry and rough yolk even may cause choking

### SUMMARY OF THE INVENTION

In view of the above-described problems, it is one objective of the invention to provide an electric egg beater comprising a motor. Upon working, the motor rotates clockwise and counterclockwise to produce shearing force whereby completely mixing the egg white and the egg yolk of an egg without breaking the egg shell.

Disclosed herein is an electric egg beater, comprising a housing, a motor, a circuit board and a holding device; wherein the holding device comprise one or more clamps for holding an egg with eggshell; wherein the holding device is configured to be connected to a motor; wherein the circuit board is configured to control the motor to rotate clockwise and counterclockwise; wherein the motor is configured to drive the holding device to rotate the egg held therein clockwise and counterclockwise in alternation.

According to an embodiment, the holding device comprises two clamps which are disposed oppositely with each other.

According to an embodiment, a clamping section of the one or more clamps are cradle shaped, eggshell shaped, or arc shaped.

According to an embodiment, an interior of a clamping section of the one or more clamps is provided with a grid slot.

According to an embodiment, an interior of a clamping section of the one or more clamps is provided with a first cushion.

According to an embodiment, the holding device further comprises a screw which is disposed below the one or more clamps to adjust tension of the holding device.

According to an embodiment, the holding device further comprises a first press plate disposed above the screw and a second press plate base disposed below the screw, for securing the screw.

According to an embodiment, the one or more clamps are secured by the second press plate base and the first press plate.

According to an embodiment, an upper surface of the first press plate is provided with a second cushion.

According to an embodiment, the electric egg beater further comprises a radiation fin disposed next to the motor.

According to an embodiment, the electric egg beater further comprises a heat dissipation device.

According to an embodiment, the electric egg beater further comprises a first fan.

According to an embodiment, the housing further comprises a base, an upper cover and a middle cover; and the middle cover is disposed between the upper cover and the base.

According to an embodiment, the electric egg beater further comprises a switch button and an external power interface.

According to an embodiment, the electric egg beater further comprises a ventilation hole on the housing.

According to an embodiment, the housing is egg-shaped.

According to an embodiment, a method of using the electric egg beater comprises: mounting the egg with intact eggshell in the holding device, and mixing egg white and egg yolk of the egg by rotating the egg clockwise and counterclockwise in alternation.

According to an embodiment, the method of using the electric egg beater further comprises: mounting the egg so that a long axis of the egg is nonparallel with an axis of rotation of the egg.

According to an embodiment, a method comprising: mounting an egg with intact eggshell in a holding device, and mixing egg white and egg yolk of the egg by rotating the egg clockwise and counterclockwise in alternation.

According to an embodiment, the method further comprises: mounting the egg so that a long axis of the egg is nonparallel with an axis of rotation of the egg.

Advantages of the electric egg beater according to embodiments of the invention are summarized as follows. The electric egg beater enables the egg white and egg yolk to be mixed uniformly and rapidly without breaking the egg shell, and the original quality, flavor and taste of the egg are kept. The mixing is convenient, safe and reliable, and benefits the post-processing of the egg. No mixing vessel is involved in the mixing, thereby saving the labor for washing and preventing the egg liquid from being exposed in the air. The uniformly mixed shell-intact egg can be steamed or boiled directly, the taste is soft and smooth, no layering occurs, and the product is compact and golden yellow, which is particularly suitable for the dish carving and creation. In addition, no pure yolk is produced, thereby avoiding the hidden danger of chocking caused to elderlies and children.

### BRIEF DESCRIPTION OF THE DRAWINGS

The invention is described herein below with reference to the accompanying drawings, in which:

FIG. 1 is a schematic diagram of an electric egg beater in accordance with one embodiment of the invention;

FIG. 2 is a schematic diagram of an upper cover in accordance with one embodiment of the invention;

FIG. 3 is a schematic diagram of a middle cover in accordance with one embodiment of the invention;

FIG. 4 is a schematic diagram of a base in accordance with one embodiment of the invention;

FIG. 5 is a schematic diagram of a screw in accordance with one embodiment of the invention;

FIG. 6 is a schematic diagram of a press plate in accordance with one embodiment of the invention;

FIG. 7 is a schematic diagram of a press plate base in accordance with one embodiment of the invention;

FIG. 8 is a schematic diagram of a radiation fin in accordance with one embodiment of the invention; and

FIG. 9 is a schematic diagram of a holding device in accordance with one embodiment of the invention.

In the drawing, the following reference numbers are used: 1. Upper cover; 2. Middle cover; 3. Base; 4. Motor; 5. Clamp; 6. First press plate; 7. Screw; 8. Second press plate base; 9. Radiation fin; 10 Circuit board; 11. Switch button; 12. External power interface; 13. First fan; 14. Second fan; 15, Shaft; 16, Shaft entry hold, 17, Screw hole; 18, Clamp section; 19, Grid slot; 20, First rubber mat; 21 Second rubber mat; Housing, 100; Holding device, 200.

### DETAILED DESCRIPTION OF THE EMBODIMENTS

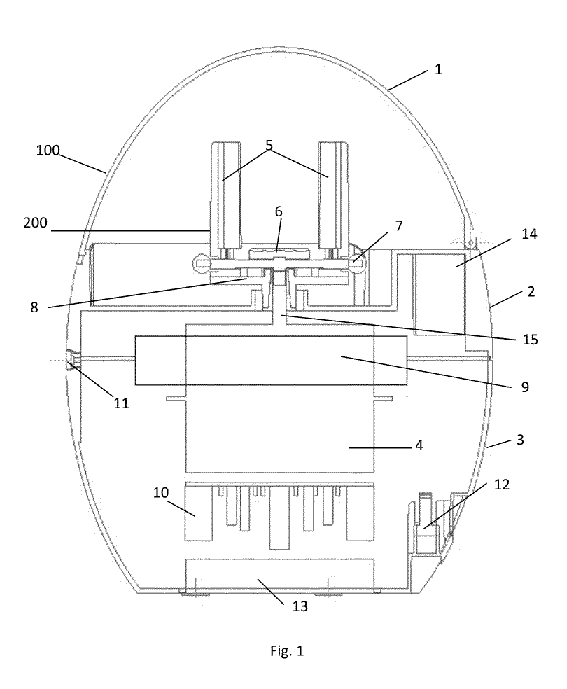

As shown in FIG. 1, an electric egg beater comprises a housing 100, a motor 4, a circuit board 10 and a holding device 200 for holding an egg with an eggshell; wherein the holding device is configured to be connected to a motor 4; wherein the circuit board 10 is configured to control the motor 4 to rotate clockwise and counterclockwise; wherein the motor 4 is configured to drive the holding device 200 to rotate an egg held therein clockwise and counterclockwise in alternation, such that rotation causes the egg white and egg yolk of the egg to be mixed within its intact eggshell without breaking the eggshell. Specifically, without breaking the eggshell, the egg white and egg yolk of the egg are uniformly mixed under the action of shearing force resulting from the alternation between clockwise and counterclockwise rotations of the egg within the egg beater.

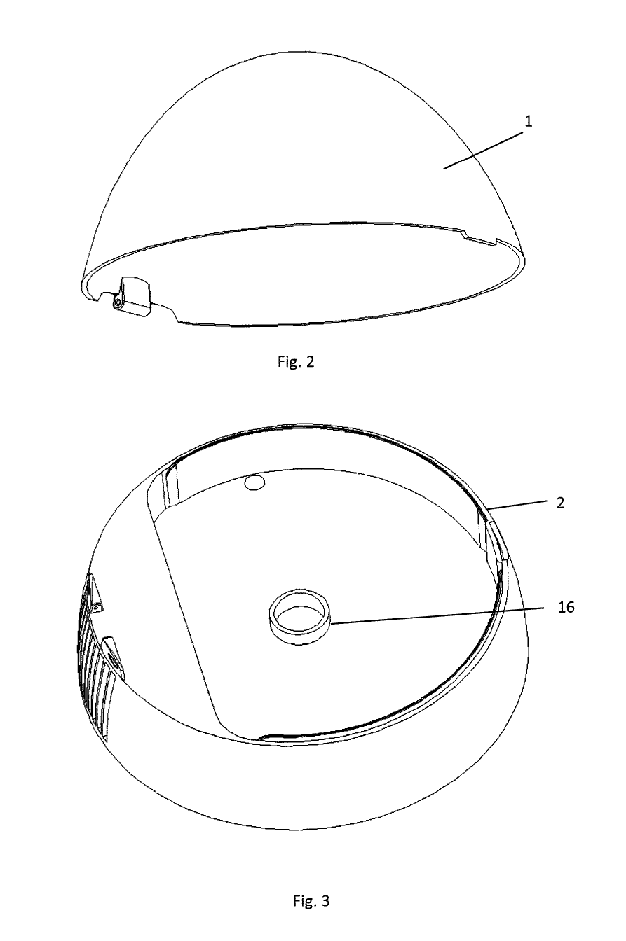

As shown in FIG. 1-4, according to an embodiment, the housing 100 further comprises a base 3, an upper cover 1 and a middle cover 2. The middle cover 2 is disposed between the upper cover 1 and the base 3. The holding device is provided in the middle section chamber within the middle cover 2.

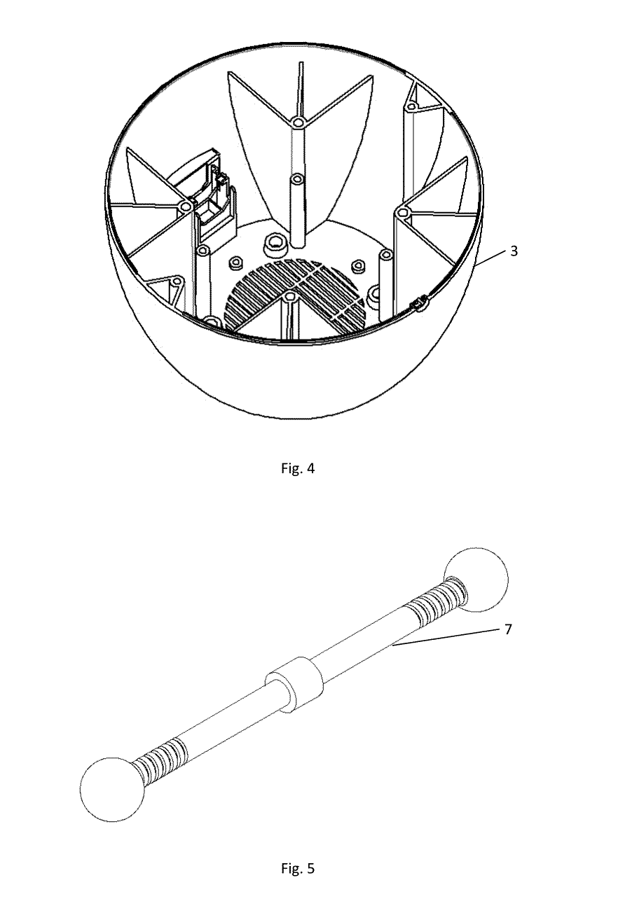

As shown in FIGS. 1 and 4, the motor 4 is disposed in a chamber in the base 3; a circuit board 10 is disposed below the motor 4 to control the operation of motor.

As shown in FIG. 1, according to an embodiment, the holding device 200 is connected to a shaft 15 of the motor 4 in a detachable manner. As shown in FIG. 3, the shaft entry hole 16 provides access to shaft 15 into the middle section chamber.

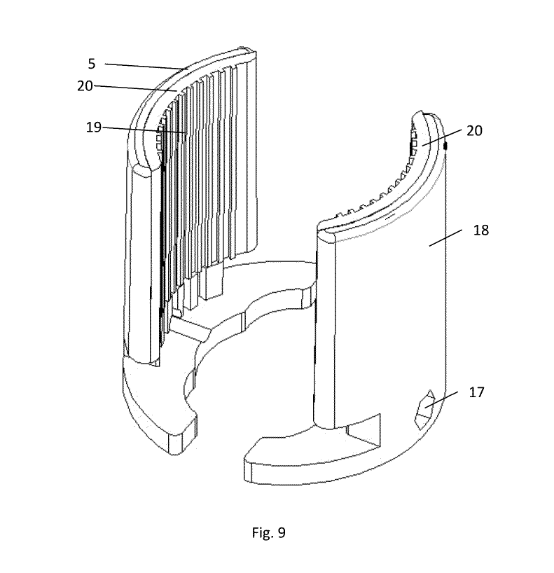

According to an embodiment, as shown in FIG. 9, the holding device 200 comprises two clamps 5 which are disposed oppositely. A screw 7, as shown in FIG. 5, is disposed on the two clamps 5 to adjust the tension of the holding device. The adjustment of tension provides user of the egg beater flexibility in installing an egg on the holding device, and in accommodating eggs of different sizes from large to medium to small. In one embodiment, the bottom part of the clamps 5 are provided with screw hole 17 for accommodating the screw 7. It is also conceivable that three or more clamps may be used in the egg beater. The clamps may be of various shapes and sizes that are suitable for holding and securing an egg within. Examples of shapes of the clamps include but are not limited to cradle shape, eggshell shape, arc shape, etc.

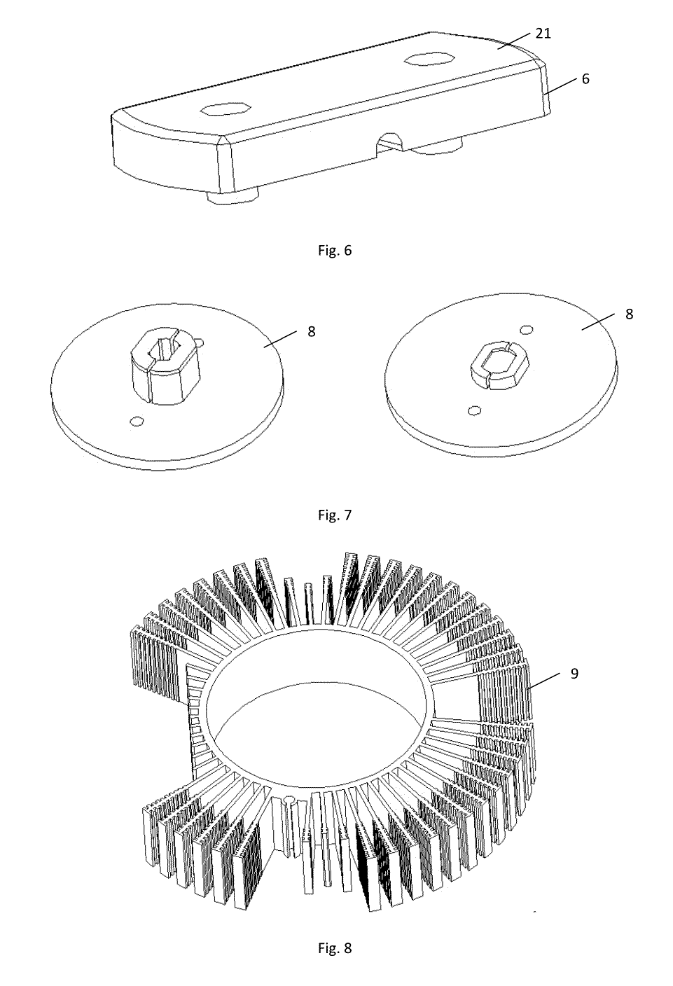

According to an embodiment, as shown in FIG. 1, the holding device 200 further comprises a first press plate 6 and a second press plate 8. According to an embodiment, as shown in FIGS. 1 and 6, a first press plate 6 is configured to be disposed above the screw 7, and as shown in FIG. 7, a second press plate base 8 is configured to be disposed below the screw 7, for securing the screw. It is conceivable that other means for securing the screw is achievable by variation of the press plates. The clamps and press plate may be made of various suitable materials that providing safe grip of an egg, low cost and strong durability. Examples of various suitable materials of the clamps and press plate include but are not limited to plastics, foam and composites, ceramics, metal and metal alloys.

As shown in FIG. 1, the clamps 5 are flexibly disposed on the press plate base 8 via the press plate 6. As shown in FIG. 9, a clamping section 18 of the clamps 5 is arc-shaped. Optionally, the interior of the clamping section is provided with a grid slot 19, which may provide enhanced friction or support for holding an egg therein. Optionally, the interior of the clamping section of the clamps 5 is provided with a first cushion. A first cushion may provide enhanced friction or support or protection for holding an egg therein, and may be of various suitable materials such as foam or rubber. According to an embodiment, the first cushion is for example a first rubber mat 20, Optionally, an upper surface of the press plate 6 is provided with a second cushion. According to an embodiment, the second cushion is for example a second rubber mat 21.

According to an embodiment, the egg beater further comprises a heat dissipation device. In one embodiment, the heat dissipation device comprises one or more fans, such as a first fan 13 and/or a second fan 14 as shown in FIG. 1. The first fan 13 is optional and may be disposed at a bottom of the egg beater. The second fan 14 may be disposed at one side of the holding device. The bottom of the base 3 comprises a ventilation hole, and gaps for heat dissipation are provided between joints of components. Optionally, the motor 4 is provided with a radiation fin 9.

As shown in FIG. 1, a switch button 11 is disposed at a joint of the middle cover 2 and the base 3; and the base 3 is provided with an external power interface 12.

In one embodiment, the housing is egg-shaped. Alternatively, the housing may be of any suitable shape that may accommodate the components within. For instance, the housing may be a rectangular box shape, or a round ball shape, etc.

Further disclosed herein is a method of using the egg beater. According to an embodiment, a method of using the electric egg beater comprises: mounting the egg with intact eggshell in the holding device, and mixing egg white and egg yolk of the egg by rotating the egg clockwise and counterclockwise in alternation.

The egg may be mounted in the holding device in many different ways. According to an embodiment, the method of using the electric egg beater further comprises: mounting the egg so that a long axis of the egg is nonparallel with an axis of rotation of the egg. As used herein, an axis of rotation of the egg refers to the axis along which the egg is configured to be rotated in the electric egg beater. Normally, the shape of an egg resembles a prolate spheroid with one end larger than the other, with cylindrical symmetry along the long axis of the egg. For example, preferably, the egg may be mounted in a laid down position, so the long axis of the egg is perpendicular to the axis of rotation of the egg. The egg may also be mounted so the long axis of egg is at an angle other than 90 degrees with the axis of rotation of the egg.

Alternatively, according to an embodiment, the method of using the electric egg beater further comprises: mounting the egg so that a long axis of the egg is substantially parallel with an axis of rotation of the egg.

According to an embodiment, to start, press once the switch button 11 comprising an indicating lamp, and the motor 4 runs automatically for a predetermined amount of time. Preferably, the motor run a cycle of one minute. The running process of the motor 4 is as follows: first, rotate clockwise for 2 seconds, and then rotate counterclockwise for another 2 seconds. The clockwise and counterclockwise rotation is repeated the predetermined time is finished. Preferably, the motor 4 has a rotational speed of 2800 rpm, and a power of 90 W. The circuit board 10 comprises a capacitor, the parameters and type of which can refer to existing capacitors. During the operation, the indicating lamp is lighted. If the operation is over, the indicating lamp goes out automatically. If the switch button is pressed during the operation, the working will pause immediately, which means an emergency stop.

According to an embodiment, a method comprises: mounting an egg with intact eggshell in a holding device, and mixing egg white and egg yolk of the egg by rotating the egg clockwise and counterclockwise in alternation.

According to an embodiment, the method further comprises: mounting the egg so that a long axis of the egg is nonparallel with an axis of rotation of the egg.

According to an embodiment, the method further comprises: rotating the egg clockwise for 2 seconds; rotating the egg counterclockwise for 2 seconds; and repeating clockwise and counterclockwise rotation of the egg in alternation until a predetermined amount of time is finished.

Although the most consumed type of egg in the market is chicken egg, it is conceivable that the electric egg beater disclosed herein may be used with eggs of many different species, including but not limited to birds, reptiles, amphibians, and fish, all of which have been eaten by humans for thousands of years. According to an embodiment, more than one holding devices with different size and shape may be used interchangeably in the electric egg beater, so as to adapt to the use of different species or types of eggs by the consumers in the marketplace.

While particular embodiments of the invention have been shown and described, it will be obvious to those skilled in the art that changes and modifications may be made without departing from the invention in its broader aspects, and therefore, the claims are aimed to cover all such changes and modifications as fall within the true spirit and scope of the invention.

1. An electric egg beater, comprising a housing, a motor, a circuit board and a holding device; wherein the holding device comprise one or more clamps for holding an egg with eggshell; wherein the holding device is configured to be connected to a motor; wherein the circuit board is configured to control the motor to rotate clockwise and counterclockwise; wherein the motor is configured to drive the holding device to rotate the egg held therein clockwise and counterclockwise in alternation.

2. The electric egg beater of claim 1, wherein the holding device comprises two clamps which are disposed oppositely with each other.

3. The electric egg beater of claim 1, wherein a clamping section of the one or more clamps are cradle shaped, eggshell shaped, or arc shaped.

4. The electric egg beater of claim 1, wherein an interior of a clamping section of the one or more clamps is provided with a grid slot.

5. The electric egg beater of claim 1, wherein an interior of a clamping section of the one or more clamps is provided with a first cushion.

6. The electric egg beater of claim 1, wherein the holding device further comprises a screw which is disposed below the one or more clamps to adjust tension of the holding device.

7. The electric egg beater of claim 6, wherein the holding device further comprises a first press plate disposed above the screw and a second press plate base disposed below the screw, for securing the screw.

8. The electric egg beater of claim 7, wherein the one or more clamps are secured by the second press plate base and the first press plate.

9. The electric egg beater of claim 7, wherein an upper surface of the first press plate is provided with a second cushion.

10. The electric egg beater of claim 1, further comprising a radiation fin disposed next to the motor.

11. The electric egg beater of claim 1, further comprising a heat dissipation device.

12. The electric egg beater of claim 1, further comprising a first fan.

13. The electric egg beater of claim 1, wherein the housing further comprises a base, an upper cover and a middle cover; and the middle cover is disposed between the upper cover and the base.

14. The electric egg beater of claim 1, further comprising a switch button and an external power interface.

15. The electric egg beater of claim 1, further comprising a ventilation hole on the housing.

16. The electric egg beater of claim 1, wherein the housing is egg-shaped.

17. A method of using the electric egg beater of claim 1, comprising:
mounting the egg with intact eggshell in the holding device;
mixing egg white and egg yolk of the egg by rotating the egg clockwise and counterclockwise in alternation.

18. The method of using the electric egg beater of claim 17, comprising mounting the egg so that a long axis of the egg is nonparallel with an axis of rotation of the egg.

19. A method comprising:
mounting an egg with intact eggshell in a holding device;
mixing egg white and egg yolk of the egg by rotating the egg clockwise and counterclockwise in alternation.

20. The method of claim 19, further comprising:
mounting the egg so that a long axis of the egg is nonparallel with an axis of rotation of the egg.
